(19) United States
(12) Patent Application Publication
(10) Pub. No.: US 2024/0312269 A1
(43) Pub. Date: Sep. 19, 2024

(54) VEHICLE REPLACEMENT SIMULATION DEVICE AND VEHICLE REPLACEMENT SIMULATION METHOD

(71) Applicant: HONDA MOTOR CO., LTD., Tokyo (JP)

(72) Inventors: Naohiro AKUZAWA, Tokyo (JP); Kei HIROHATA, Tokyo (JP); Adil GUPTA, Tokyo (JP); Yohei UMEMOTO, Tokyo (JP); Daisuke IDE, Tokyo (JP)

(21) Appl. No.: 18/593,998

(22) Filed: Mar. 4, 2024

(30) Foreign Application Priority Data
Mar. 16, 2023 (JP) 2023-042107

(51) Int. Cl. G07C 5/08

(52) U.S. Cl. CPC G07C 5/0825; G07C 5/0808

(57) ABSTRACT

A vehicle replacement simulation device includes a vehicle information acquirer that acquires traveling information collected in a predetermined period and including location information on an internal combustion vehicle of a user and clock time information and acquires traveling distance information including departure location information and parking location information on the vehicle, clock time information, and a traveling distance, a simulation processor that calculates a required charge amount from the traveling distance information on the vehicle in the predetermined period and electric vehicle performance information, calculates a parking time at the user's home, estimates the amount of charge allowed at the home based on the parking time at the home, and further estimates charge information including the amount of charge required away from the home from the amount of charge allowed at the home, and an output processor that outputs the charge information to an information processing device of the user.

This application is based on and claims the benefit of priority from Japanese Patent Application No. 2023-042107, filed on 16 Mar. 2023, the content of which is incorporated herein by reference.

### BACKGROUND OF THE INVENTION

### Field of the Invention

The present invention relates to a vehicle replacement simulation device and a vehicle replacement simulation method that estimate a traveling distance and a home parking time from a change in location information on an internal combustion vehicle currently owned by a user and estimate charge information including any of the number of times of charge and the amount of charge particularly away from the user's home on the assumption that the user replaces the internal combustion vehicle with an electric vehicle (electric automobile) and the electric vehicle travels in a pattern similar to a current traveling pattern.

### Related Art

In recent years, in order to achieve a sustainable society, various measures have been taken to achieve carbon neutrality. For this reason, electric vehicles (EVs) are being sold by vehicle manufacturers, etc. in order to avoid emitting gas such as carbon dioxide during traveling, and the choice of an electric vehicle is becoming an issue for users when purchasing their next vehicle. At the present moment, it has been pointed out that a distance (mileage per charge) that the electric vehicle can travel on one charge is generally shorter than a distance that an internal combustion vehicle (e.g., gasoline vehicle) can travel when a tank is filled up with fuel. Moreover, it has been pointed out that a time required for one charge of the electric vehicle is generally longer than a time required for filling the tank of the internal combustion vehicle (e.g., gasoline vehicle) with fuel. For these reasons, it is not easy for the user to particularly grasp, e.g., the number of times of charge and the charge time required at a charge facility away from home if the currently-owned internal combustion vehicle is replaced with the electric vehicle and the electric vehicle travels in a pattern similar to the traveling pattern of the internal combustion vehicle, and the user's concerns regarding a replacement cannot be alleviated. On this point, Japanese Patent No. 6236887 discloses a technique for accurately calculating a battery power consumption required for an electric vehicle to travel a road link. Specifically, a technique is disclosed for accurately calculating a battery power consumption required for an electric vehicle to travel a predetermined road section according to the number of times of stop estimated for the predetermined road section. However, in the technique described in Japanese Patent No. 6236887, if a user replaces a currently-owned internal combustion vehicle with the electric vehicle and the electric vehicle travels in a pattern similar to the traveling pattern of the internal combustion engine, the extent of what is required, such as the number of times of charge and a charge time, at a charge facility away from the home cannot be particularly grasped. For this reason, in order to grasp the extent of what is required, such as the number of times of charge and the charge time, at the charge facility away from the home, it is necessary to analyze the current traveling pattern of the internal combustion vehicle by the user oneself, calculate an expected power consumption, and particularly calculate the extent of what is required, such as the number of times of charge and the charge time, at the charge facility away from the home from the expected power consumption calculated by the user oneself. This is practically difficult for the user. Thus, the user's concerns regarding a replacement have not yet been alleviated.
Patent Document 1: Japanese Patent No. 6236887

### SUMMARY OF THE INVENTION

There has been a demand for a technique for estimating charge information including particularly any of the amount of charge and the number of times of charge required at a charge facility away from a user's home in a case where an internal combustion vehicle currently owned by the user is replaced with an electric vehicle (electric automobile) and the electric vehicle travels in a pattern similar to a current traveling pattern and alleviating the user's concerns regarding a replacement.

The present invention has been made in view of these problems, and is intended to provide a vehicle replacement simulation device and a vehicle replacement simulation method that estimate a traveling distance and a home parking time from a change in location information on an internal combustion vehicle currently owned by a user and estimate charge information including any of the number of times of charge and the amount of charge particularly at a charge facility away from the user's home in a case where the user replaces the internal combustion vehicle with an electric vehicle (electric automobile) and the electric vehicle travels in a pattern similar to a current traveling pattern. With this configuration, it is possible to alleviate the user's concerns by providing the user with objective information that will help the user make an informed decision regarding replacement of the internal combustion vehicle with an electric vehicle.
(1) A vehicle replacement simulation device (e.g., later-described vehicle replacement simulation device 1) according to one aspect of the present invention includes a map information storage (e.g., later-described map information storage 121) that stores map information including charge facility information having road information and the location of a charge facility, an electric vehicle information storage (e.g., electric vehicle information storage 123) that stores electric vehicle performance information regarding traveling performance of an electric vehicle including a motor to be driven with electricity, a vehicle information acquirer (e.g., later-described vehicle information acquirer 110) that acquires traveling information collected in a predetermined period and including at least location information on an internal combustion vehicle (later-described vehicle 20) of a user including an internal combustion engine and clock time information and acquires traveling distance information including at least departure location information and parking location information on the internal combustion vehicle of the user including the internal combustion engine, clock time information, and a traveling distance in the predetermined period, a simulation processor (e.g., later-described simulation processor 111) that calculates a required power amount from the traveling distance information on the internal combustion vehicle in the predetermined period and the electric vehicle performance information, calculates a parking time at a home of the user, estimates the amount of charge allowed at the home of the user based on the parking time at the home of the user, and further estimates, from the amount of charge allowed at the home, charge information including any of the amount of charge or the number of times of charge required away from the home based on the map information, and an output processor (e.g., later-described output processor 112) that outputs the charge information to an information terminal of the user.

According to (1) above, the extent of what is required away from the home in a case where the user replaces the internal combustion vehicle with the electric vehicle can be easily grasped, leading to alleviation of the user's concerns regarding a replacement.
(2) In the vehicle replacement simulation device (e.g., later-described vehicle replacement simulation device 1) according to (1) above, the electric vehicle information storage may store the electric vehicle performance information for each of a plurality of electric vehicle types, the simulation processor (e.g., later-described simulation processor 111) may estimate the charge information for each of the plurality of electric vehicle types, and the output processor (e.g., later-described output processor 112) outputs the charge information on each of the plurality of electric vehicle types.

According to (2) above, the extent of what is required away from the home in a case where the user replaces the internal combustion vehicle with the electric vehicle can be grasped for each of the plurality of vehicle types.
(3) In the vehicle replacement simulation device (e.g., later-described vehicle replacement simulation device 1) according to (1) or (2) above, the map information storage (e.g., later-described map information storage 121) may store power capability information regarding the power capability of a charger (e.g., quick charger) in the charge facility information, and the simulation processor (e.g., later-described simulation processor 111) may calculate, as charge information, a charge time in the predetermined period from the power capability information and the electric vehicle performance information.

According to (3) above, the degree and time of charge required away from the home in a case where the user replaces the internal combustion vehicle with the electric vehicle can be more accurately grasped.
(4) In the vehicle replacement simulation device (e.g., later-described vehicle replacement simulation device 1) according to (1) to (3) above, the map information storage (e.g., later-described map information storage 121) may store information regarding a fueling facility for fueling the internal combustion engine in the map information, and the simulation processor (e.g., later-described simulation processor 111) excludes, from the traveling information on the internal combustion vehicle (later-described vehicle 20), traveling information indicating the fueling facility for fueling the internal combustion engine as the destination of the internal combustion vehicle, and calculate the charge information.

According to (4) above, in a case where the user replaces the internal combustion vehicle with the electric vehicle, traveling to the fueling facility unrelated to the electric vehicle is excluded so that the time of charge required away from the home can be more accurately calculated.
(5) The vehicle replacement simulation method of the present invention is a vehicle replacement simulation method executed by a computer, which includes
a map information storage step of storing map information including charge facility information having road information and a location of a charge facility,
an electric vehicle information storage step of storing electric vehicle performance information regarding traveling performance of an electric vehicle including a motor to be driven with electricity,
a vehicle information acquiring step of acquiring traveling information collected in a predetermined period and including at least location information on an internal combustion vehicle (later-described vehicle 20) of a user including an internal combustion engine and clock time information and acquiring traveling distance information including at least departure location information and parking location information on the internal combustion vehicle of the user including the internal combustion engine, clock time information, and a traveling distance in the predetermined period,
a simulation processing step of calculating a required power amount from the traveling distance information on the internal combustion vehicle in the predetermined period and the electric vehicle performance information, calculating a parking time at a home of the user, estimating the amount of charge allowed at the home of the user based on the parking time at the home of the user, and further estimating, from the amount of charge allowed at the home, charge information including any of the amount of charge or the number of times of charge required away from the home based on the map information, and
an output processing step of outputting the charge information to an information terminal of the user.

According to the method of (5) above, advantageous effects similar to those of the vehicle replacement simulation device of (1) above can be obtained.

The present invention is intended to provide the vehicle replacement simulation device and the vehicle replacement simulation method that estimate the traveling distance and the home parking time from the change in the location information on the internal combustion vehicle currently owned by the user and estimate the charge information including any of the number of times of charge and the amount of charge particularly at the charge facility away from the user's home in a case where the user replaces the internal combustion vehicle with the electric vehicle (electric automobile) and the electric vehicle travels in a pattern similar to the current traveling pattern. With this configuration, it becomes possible to provide objective information to a user considering replacing their internal combustion vehicle.

### BRIEF DESCRIPTION OF THE DRAWINGS

FIG. 1 is a schematic diagram showing a vehicle replacement simulation system in an embodiment of the present invention;

FIG. 2 is a block diagram showing a basic configuration of a vehicle replacement simulation device in the embodiment of the present invention;

FIG. 3 is a table showing one example of electric vehicle information in the embodiment of the present invention;

FIG. 4A is a flowchart showing vehicle replacement simulation processing in the embodiment of the present invention; and

FIG. 4B is a flowchart showing the vehicle replacement simulation processing in the embodiment of the present invention.

### DETAILED DESCRIPTION OF THE INVENTION

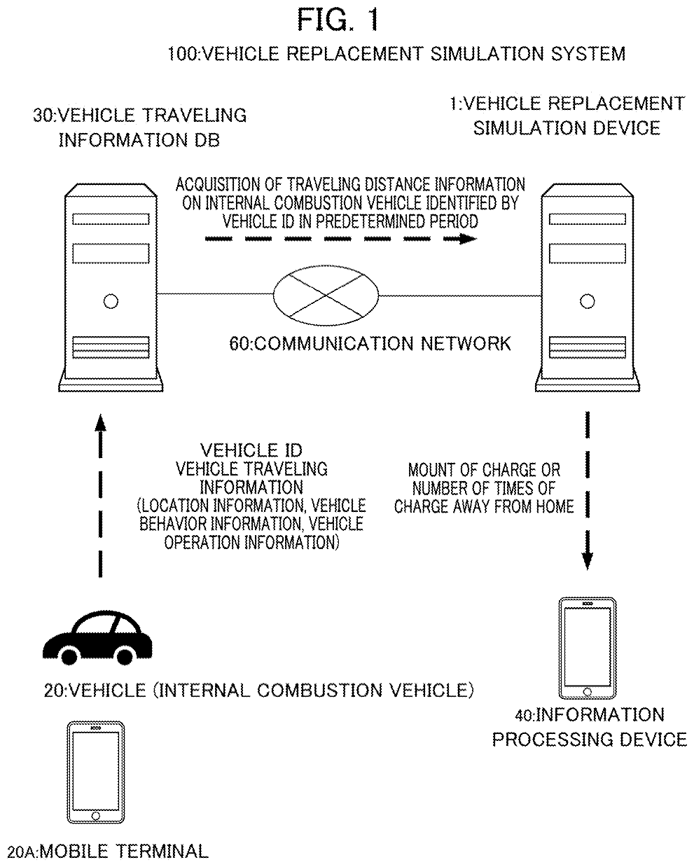

Hereinafter, one preferred embodiment of a vehicle replacement simulation device of the present invention will be described with reference to the figures. FIG. 1 shows a basic configuration of a vehicle replacement simulation system 100. The vehicle replacement simulation system 100 includes a vehicle replacement simulation device 1, a vehicle 20, a floating car data (FCD) database system (also referred to as a “vehicle traveling information database system”) 30, a communication network 60, and an information processing device 40. Note that as described later, the vehicle replacement simulation system 100 may include a mobile terminal 20A carried by a user and the mobile terminal 20A may acquire vehicle traveling information on the vehicle 20 and transmit the vehicle traveling information to the vehicle traveling information database system 30. The vehicle 20 is an internal combustion vehicle (e.g., gasoline vehicle), and is a connected car based on a telematics technique. The vehicle 20 is communicable with a connected system (not shown) managed by a manufacturer of the vehicle 20, and is configured to transmit location information, vehicle operation information, vehicle behavior information, etc. on each vehicle 20 to the FCD database system (vehicle traveling information database system) 30 via the communication network 60 together with clock time information. Hereinafter, unless otherwise specified, the vehicle 20 means the internal combustion vehicle. Note that the vehicle traveling information including the location information, the vehicle operation information, and the vehicle behavior information on each vehicle 20 is stored in association with a vehicle ID in the floating car data (FCD) database system (vehicle traveling information database system) 30. A customer ID for identifying an owner of the vehicle 20 specified by the vehicle ID is associated with the vehicle ID, for example, in the connected system.

The location information on the vehicle 20 includes, for example, location information (latitude, longitude) acquired on the vehicle 20 by reception of a GPS signal by a GPS sensor. Note that the accuracy of acquisition of the location information may be further enhanced, for example, based on an angular velocity and an acceleration measured by a gyro sensor and an acceleration sensor. The vehicle behavior information is information regarding the behavior of the vehicle 20, and for example, includes an engine speed, a vehicle speed, the traveling direction of the vehicle 20, a wheel speed, and an acceleration (longitudinal acceleration, lateral acceleration, and vertical acceleration). The vehicle operation information is information regarding operation by a driver, and for example, includes ignition ON/OFF information, various pedal operation amounts (amounts of operation of an accelerator pedal, a brake pedal, etc.), the steering angle of a steering wheel, ON/OFF operation information on various lamps (ON/OFF information on a headlight, a parking light, a brake light, a hazard light, a blinker, etc.), and a windshield wiper operation amount.

Note that in the present embodiment, a configuration in which the vehicle traveling information is transmitted from the vehicle 20 to the floating car data (FCD) database system (vehicle traveling information database system) 30 will be described as an example, but the present invention is not limited thereto. For example, the user may get on the vehicle 20 with carrying the mobile terminal 20A, and turn on a start switch of the vehicle 20, such as an ignition switch. Accordingly, the vehicle 20 and the mobile terminal 20A may be connected to (paired with) each other, and, e.g., the location information and a mobile object ID acquired by the mobile terminal 20A may be transmitted to the floating car data (FCD) database system (vehicle traveling information database system) 30. Further, the mobile terminal 20A may acquire the vehicle traveling information on the vehicle 20, and may transmit the vehicle traveling information to the floating car data (FCD) database system (vehicle traveling information database system) 30.

In the present embodiment, the information processing device 40 may be provided as a client terminal of the vehicle replacement simulation device 1. The information processing device 40 includes, for example, a PC, a tablet terminal, a smartphone, and a mobile terminal, and may be a client terminal owned by the user who is the owner of the vehicle 20. In this case, the user may instruct (input an instruction to) the vehicle replacement simulation device 1 via the information processing device 40 to perform simulation processing in a case where the internal combustion vehicle owned by the user oneself is replaced with an electric vehicle, and output information regarding a simulation result output from the vehicle replacement simulation device 1 may be displayed on the information processing device 40. The outline of the system configuration in the present embodiment has been described above. Next, the vehicle replacement simulation device 1 will be described.

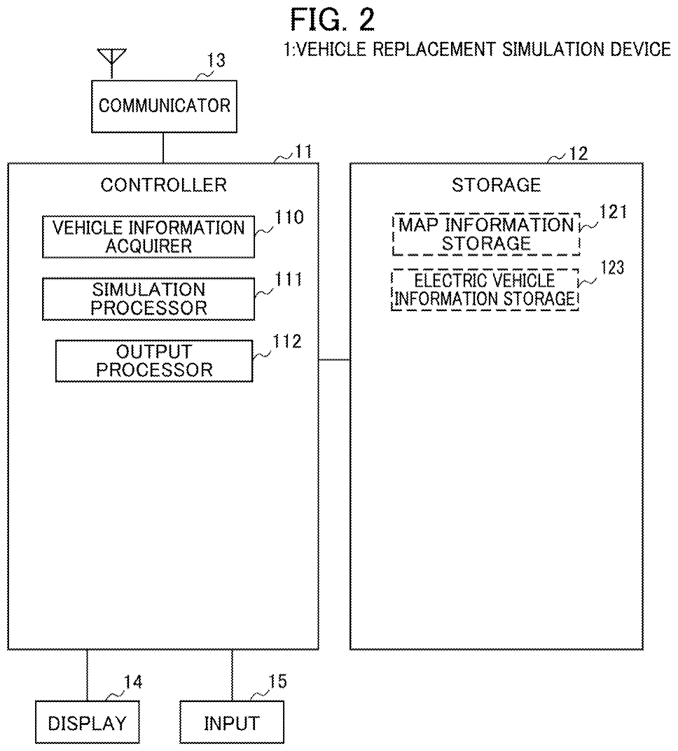

FIG. 2 is a block diagram showing a basic configuration of the vehicle replacement simulation device 1. As shown in FIG. 2, the vehicle replacement simulation device 1 includes a controller 11, a storage 12, a communicator 13, a display 14, and an input 15.

The controller 11 includes an arithmetic processing device such as a microprocessor, and controls each component forming the vehicle replacement simulation device 1. Details of the controller 11 will be described later.

The storage 12 includes, for example, a semiconductor memory, and stores control programs called firmware and an operating system, programs such as programs for acquiring vehicle information and performing the simulation processing and output processing, and various other types of information such as map information, charge facility information, and electric vehicle performance information. As shown in FIG. 2, the storage 12 includes a map information storage 121 and an electric vehicle information storage 123. In the present embodiment, a configuration in which the map information includes the charge facility information will be described as an example, but the present invention is not limited thereto. The charge facility information may be stored in a charge facility information storage (not shown).

The map information storage 121 stores facility information including road information, facility type information indicating the attribute of each of a plurality of facilities, facility location information associated with each of these facilities, etc. In the present embodiment, the charge facility information is included as the facility information. The charge facility information includes, for example, facility type information indicating a charge facility, a charge facility identification number (charge facility ID) for identifying the charge facility, a charge facility name, location information (including information on a road facing the charge facility) on the charge facility, a telephone number, an address, business hours, and power capability information on a charger placed at the charge facility. Here, the power capability information indicates, for example, a charge method (normal charge, quick charge) and an output amount (power supply per hour; in the case of the CHAdeMO standard, quick charge with, e.g., approximately 20 kW to 50 kW or 60 kW, 90 kW, 150 KW, or 250 kW in manufacturer's own specifications). Note that the map information storage 121 may store, for example, fueling facility (fuel station) information in addition to the charge facility information. The fueling facility information includes, for example, facility type information indicating a fueling facility, a fueling facility name, and location information (including information on a road facing the fueling facility) on the fueling facility.

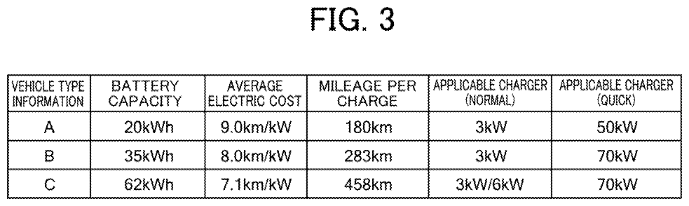

The electric vehicle information storage 123 stores, for example, the electric vehicle performance information on each type of electric vehicle sold by a vehicle manufacturer. FIG. 3 is a table showing one example of the electric vehicle performance information. As shown in FIG. 3, the electric vehicle performance information includes, for each commercially-available electric vehicle, vehicle type information (including a vehicle name etc.) on the electric vehicle, a battery capacity (kWh), an average electric cost (Wh/km), a mileage per charge, applicable normal charge (normal charge with 3 kW or 6 kW), and applicable quick charge (maximum output of applicable quick charge; for example, up to an output of 50 kW or 70 kW), for example. Arbitrary normal charge and arbitrary quick charge are not applicable to the electric vehicle, and an applicable normal charge output amount and an applicable quick charge output amount are determined in advance according to the type of electric vehicle. By selecting the type of electric vehicle as shown in FIG. 3, the normal charge output and quick charge output applicable to the electric vehicle are determined.

The storage 12 has been described above, but for example, the facility information stored in the map information storage 121 may be stored in advance or be downloaded as necessary from, e.g., a server device (not shown) connected to the communication network 60. These types of information may be corrected as necessary according to, e.g., user input.

The communicator 13 has a DSP etc., and implements wireless communication or wired communication with other devices (e.g., the above-described server) via the communication network 60 in accordance with a standard such as long term evolution (LTE), 4th generation (4G), 5th generation (5G), or Wi-Fi (registered trademark). Note that the communication network 60 is implemented by a network such as the Internet or a mobile telephone network or a combination thereof. Part of the network may include a local area network (LAN).

The display 14 includes, for example, a display device such as a liquid crystal display or an organic electroluminescence display. The display 14 displays an image in response to an instruction from the controller 11. The input 15 includes, for example, an input device such as a physical switch called a numeric keypad or a touch panel provided on a display surface of the display 14. Note that as described above, in a case where the information processing device 40 is provided as the client terminal of the vehicle replacement simulation device 1, the user may instruct (input an instruction to) the vehicle replacement simulation device 1 via the information processing device 40 to perform the simulation processing in a case where the internal combustion vehicle owned by the user oneself is replaced with the electric vehicle, and the output information regarding the simulation result output from the vehicle replacement simulation device 1 may be displayed on the information processing device 40.

Next, the details of the controller 11 will be described. The controller 11 includes the microprocessor having a CPU, a RAM, a ROM, a I/O, etc. The CPU executes each program read from the ROM or the storage 12, and upon such execution, reads information from the RAM, the ROM, and the storage 12, writes information in the RAM and the storage 12, and exchanges a signal with the communicator 13. The processing in the present embodiment is implemented by cooperation of hardware and software (program) as described above.

As shown in FIG. 2, the controller 11 includes, as functional blocks, a vehicle information acquirer 110, a simulation processor 111, and an output processor 112.

From the vehicle traveling information database system 30, the vehicle information acquirer 110 acquires daily traveling information, which includes the location information on the vehicle 20 of the user and the clock time information, on the vehicle 20 owned by the user and including an internal combustion engine in a predetermined period specified by the user. In a case where the vehicle leaves home in the morning, travels between transit points including a parking location with, e.g., a workplace as a daily destination, and returns home in the evening (or the night), the vehicle information acquirer 110 acquires, based on the daily traveling information in the predetermined period from the vehicle traveling information database system 30, the clock time of departure from home and the clock time of return home, and acquires information including a traveling distance between the transit points, the clock time of arrival at each transit point, the clock time of departure from each transit point, etc. as traveling distance information on the vehicle 20 of the user on weekday (each day of the week). In a case where on holiday such as Saturday or Sunday, the vehicle leaves home, travels between transit points including a parking location with, e.g., a location (e.g., restaurant, park, or entertainment facility) different from the workplace which is the daily destination as a destination, and returns home in the evening (or the night), the vehicle information acquirer 110 may acquire the clock time of departure from home and the clock time of return home, and acquire information including a traveling distance between the transit points, the clock time of arrival at each transit point, the clock time of departure from each transit point, etc. as traveling distance information on the vehicle 20 of the user on holiday. With this configuration, in a case where the vehicle 20 is replaced with the electric vehicle, for example, the degree and necessity of charge required away from home on weekdays and the degree and necessity of charge required away from home on holidays can be easily grasped, as described later.

Based on the traveling distance information acquired on the vehicle 20 of the user in the predetermined period (e.g., one month) by the vehicle information acquirer 110, the simulation processor 111 calculates, for each vehicle type stored in the electric vehicle information storage 123, the amount of charge or the number of times of charge required away from home in the predetermined period in a case where the vehicle 20 is replaced with the electric vehicle of such a vehicle type. In this case, for example, if the user specifies one or more vehicle types, the simulation processor 111 may acquire, from the electric vehicle information corresponding to each of these vehicle types, the electric vehicle performance information such as the battery capacity, the average electric cost, and a charge time (quick charge) with reference to the electric vehicle information storage 123, and perform simulation for each vehicle type. Note that the simulation processor 111 may select, for example, a plurality of vehicle types different from each other in the battery capacity, the average electric cost, and the charge time (quick charge) from the electric vehicle information stored in the electric vehicle information storage 123, and perform simulation for each vehicle type. For example, simulation may be performed for each of vehicle types A to C shown as an example in FIG. 3.

The simulation processor 111 may exclude traveling for fueling the vehicle 20 from the target for vehicle replacement simulation in the present embodiment because such traveling is traveling not required after the vehicle 20 has been replaced with the electric vehicle. Specifically, the simulation processor 111 may determine, with reference to the map information, whether or not the transit point (parking location) is the fueling facility, and in a case where the transit point is the fueling facility, exclude, for example, information on traveling immediately before the transit point which is the fueling facility as a destination and information on traveling immediately after the transit point which is the fueling facility as an origin from the target for vehicle replacement simulation. With this configuration, the amount of charging time required away from home in a case where the user replaces the vehicle 20 with the electric vehicle can be more accurately calculated.

Similarly, the simulation processor 111 may exclude traveling information in a case where the traveling distance information on the vehicle 20 indicates that the vehicle leaves the home, but does not return home in the evening (or the night) (e.g., a family trip or a business trip) from the target for vehicle replacement simulation in the present embodiment because such traveling is different from a normal traveling pattern. With this configuration, the amount of charging time required away from home in a daily traveling pattern in a case where the user replaces the vehicle 20 with the electric vehicle can be more accurately calculated.

Before description of the simulation processor 111, the predetermined period, a capacity chargeable at home, and the amount of power required for the electric vehicle to travel a total traveling distance (or an inter-transit-point traveling distance) will be described.

A parking time (e.g., time until the clock time of departure on a certain day after the clock time of return home on a previous day) in a time period in which the vehicle is chargeable at home is taken as a charge time in which the vehicle is chargeable at home. Note that the time (time rounded down to the nearest minute) until the clock time of departure on the certain day after the clock time of return home on the previous day, which is acquired by the vehicle information acquirer 110 on a daily basis, may be calculated as a daily home charge time. Note that in a case where the user sets the home charge time period in advance, the time in which the vehicle is chargeable at home may be set as a default value. In normal charge at home, the power supply per hour is 3 kWh or 6 kWh according to the electric vehicle type, and therefore, the maximum amount of charge allowed at home can be calculated from the product of the power supply per hour and the home charge time (day of the week j). Assuming that the time in which the vehicle is chargeable at home is, for example, 13 hours, the maximum amount of charge is 39 kwh or 78 kWh. In description below, the amount of charge allowed at home will be referred to as a “home charge amount.” Thus, the battery charge amount (referred to as a “departure charge amount”) of the electric vehicle at the time of departure from home is the sum of a remaining battery charge amount on the previous day and the home charge amount.

Departure Charge Amount=Remaining Battery Charge Amount on Previous Day+Home Charge Amount (Expression 1)

Here, assuming that the parking time at home is X hour (s), the maximum amount of charge allowed by normal charge at home is 3× (kWh) or 6× (kWh) according to the electric vehicle type, as described above. For example, assuming that the parking time X at home is 13 hours, a home charge capacity PH is 39 kWh or 78 kWh. Note that a battery cannot be charged beyond its battery capacity, and for this reason, “Remaining Battery Charge Amount on Previous Day+Home Charge Amount” does not exceed the battery capacity. That is, the home charge amount does not exceed a charge amount obtained by subtracting the remaining battery charge amount on the previous day from the battery capacity.

The simulation processor 111 calculates the product of the two values as shown in Expression 1 based on the traveling distance information (e.g., the inter-transit-point traveling distance) acquired by the vehicle information acquirer 110 in the predetermined period on a daily basis and the average electric cost (Wh/km) of the electric vehicle, thereby obtaining the amount of charge required for the electric vehicle to travel between the transit points. Note that as shown in FIG. 3, the average electric cost is set for each electric vehicle type.

Amount of Charge Required for Electric Vehicle to Travel between Transit Points=Average Electric Cost×Inter-Transit-Point Traveling Distance (Expression 2)

The amount of charge (referred to as a “required charge amount”) required for the electric vehicle to travel the total traveling distance on this date and time can be calculated from Expression 3.

Amount of Charge Required for Electric Vehicle to Travel Total Traveling Distance=Σ_{inter-transit-point distance} Amount of Charge Required for Electric Vehicle to Travel between Transit Points=Average Electric Cost×Total Traveling Distance (Expression 3)

In a case where the amount of charge required for the electric vehicle to travel the total traveling distance exceeds the amount of charge of the electric vehicle at the time of departure, charge at home is required. In this case, if the electric vehicle is charged in a small remaining battery charge amount, the charge amount (charge time) per charge is increased, but the number of times of charge can be decreased. Conversely, in a case where the electric vehicle is charged in a great remaining battery charge amount, the number of times of charge is increased, but the charge amount (charge time) per charge can be decreased because the battery cannot be charged beyond (Battery Capacity−Current Charge Amount). The user may select either case before the simulation processing, for example. Alternatively, the user may select either case based on the simulation result.

Next, the processing of the simulation processor 111 will be described. Hereinafter, four weeks will be described as an example of the predetermined period for the sake of simplicity in description. Each week of the predetermined period is identified as a week (j) such as a first week, a second week, a third week, and a fourth week, assuming that j satisfies 1≤j≤4. The week (j) (1≤j≤4) includes the days of the week, which are Monday (j), Tuesday (j), Wednesday (j), Thursday (j), Friday (j), Saturday (j), and Sunday (j). Note that the predetermined period is not limited to the four weeks. The predetermined period may be an arbitrary period. For example, in a case where the current traveling information on the vehicle 20 is similar for the same day of the week, the predetermined period may be one week including Monday to Sunday (or Sunday to Saturday).

First, the simulation processor 111 calculates the need to charge away from home in traveling on Monday (1) which is the first day of the first week of the predetermined period. The amount of charge of the electric vehicle at the time of departure from home on Monday (1) is only the home charge amount (Monday (1)) on this day, assuming that the remaining battery charge amount on a previous day is zero. Note that the remaining battery charge amount on the previous day is not necessarily zero and may be set to an arbitrary value. The simulation processor 111 compares the amount of power (“Required Charge Amount (Monday (1))”) required for the electric vehicle to travel the total traveling distance on Monday (1) and the amount of charge (“Departure Charge Amount (Monday (1))”) of the electric vehicle at the time of departure from home on Monday (1) with each other. In a case where Required Charge Amount (Monday (1))≤ Departure Charge Amount (Monday (1)) (Condition 1) is satisfied, it can be determined that charge is not required away from home. In this case, the remaining battery charge amount of the electric vehicle after the electric vehicle has returned home is a remaining battery charge amount (“Remaining Amount (Monday (1))”) before charge at home at the time of departure from home on Tuesday (1) which is the next day. Such a remaining amount can be calculated from Expression 4.

Remaining Amount after Return Home on Monday Remaining Amount (Monday (1))=Departure Charge Amount (Monday (1))−Required Charge Amount (Monday (1)) (Expression 4)

### Conversely,

in a case where Required Charge Amount (Monday (1))>Departure Charge Amount (Monday (1)) (Condition 2) is satisfied, it can be calculated that at least charge calculated from Expression 5 is required as the amount of charge away from home. Note that in the present embodiment, it is assumed that as the amount of charge required away from home, the electric vehicle is only charged by a shortfall (minimum required charge amount) shown in Expression 5. Thus, the minimum required charge amount away from home is clearly obtained.

Amount of Charge away from Home (Monday (1))=Required Charge Amount (Monday (1))−Departure Charge Amount (Monday (1)) (Expression 5)

Hereinafter, the amount of charge away from home on Monday (1) will be expressed as f (Monday (1)). Similarly, the amount of charge away from home on each day of the week (j) will be hereinafter expressed as f (Day of Week (j)). In a case where charge away from home is not required, f (Day of Week (j))=0. In a case where charge away from home is required, f (Day of Week (j)) is a positive value. Note that in a case where f (Monday (1)) is zero, the remaining amount (Tuesday (1)) is zero or more. Conversely, in a case where f (Monday (1)) is a positive value, the remaining amount (Tuesday (1)) is zero as described above.

Next, the simulation processor 111 calculates the need to charge away from home in traveling on Tuesday (1). Specifically, the required charge amount (Tuesday (1)) in a case where the electric vehicle travels the total traveling distance on Tuesday (1) and the departure charge amount (Tuesday (1)) of the electric vehicle at the time of departure from home on Tuesday (1) are compared with each other. Here, the departure charge amount (Tuesday (1)) is expressed by Departure Charge Amount (Tuesday (1))=Remaining Amount (Monday (1))+Home Charge Amount (Tuesday (1)). As in the case of Monday (1), in a case where Condition 1 which is Required Charge Amount (Tuesday (1))≤Departure Charge Amount (Tuesday (1)) is satisfied,
it is determined that charge away from home is not required.

Further, the remaining amount (Wednesday (1)) can be calculated based on an expression similar to Expression 4. Remaining Amount (Tuesday (1))=Departure Charge Amount (Tuesday (1))−Required Charge Amount (Tuesday (1))

### Conversely,

in a case where Required Charge Amount (Tuesday (1))>Departure Charge Amount (Tuesday (1)) is satisfied,
it can be calculated that at least the following charge is required as the amount of charge away from home based on an expression similar to Expression 5.

Amount of Charge away from Home (Tuesday (1))=Required Charge Amount (Tuesday (1))−Departure Charge Amount (Tuesday (1))

Subsequently, the simulation processor 111 chronologically performs processing similar to the above-described processing for the days up to Sunday (4) which is the last day of the last week so that the amount of charge away from home in the predetermined period (four weeks) can be calculated from Expression 6.

Amount of Charge away from Home=Σ_{Monday≤Day of Week≤Sunday}Σ_{1≤j≤4}f (Power Capacity on Day of Week (j)) (Expression 6)

The number of times of charge away from home can be calculated from Expression 7 by charge by one power supply as long as the amount of charge away from home does not exceed the battery capacity of the electric vehicle.

Number of Times of Charge away from Home=#{Day of Week (j); f (Power Capacity on Day of Week (j))>0} (Expression 7)

Here, #{Day of Week (j); f (Power Capacity on Day of Week (j))>0} indicates the number of days of the week (j) in which f (Power Capacity on Day of Week (j))>0 is satisfied. Note that in a case where the amount of charge away from home exceeds the battery capacity of the electric vehicle, charge is separately performed, for example, two or more times. The number of times of charge is calculated assuming that the power for the required charge amount is supplied by one charge, but the present invention is not limited thereto. For example, in a case where the charge time for quick charge is limited to within 30 minutes, the number of times of charge by quick charge within 30 minutes may be calculated assuming that quick charge within 30 minutes is taken as one charge. As described later, the available charge facility is selected based on the map information (charge facility information included therein) so that the simulation processor 111 can more realistically calculate the amount of charge away from home in addition to, e.g., the amount of charge or the number of times of charge away from home in the predetermined period based on the power capability information on the selected charge facility and the electric vehicle performance information.

In description above, the method in which the time (rounded down to the nearest minute) until the clock time of departure on the certain day after the clock time of return home on the previous day, which is acquired by the vehicle information acquirer 110, is calculated as the home charge time (Day of Week j) in which the electric vehicle is chargeable at home has been described as an example, but the present invention is not limited thereto. In a case where the user leaves home and returns home at similar clock times every day, e.g., a case where the user leaves home at eight and returns home at seven, the home charge time may be calculated as 12 hours or 13 hours.

The simulation processor 111 may acquire information on a charge facility located on a route on which the vehicle 20 travels. With this configuration, in a case where it is determined in simulation that charge away from home is required, the simulation processor 111 can estimate, based on the traveling distance, on which traveling path between the transit points the power capacity reaches zero, and can select the available charge facility based on the charge facility information included in the map information before traveling in which the power capacity is estimated to reach zero. Thus, the simulation processor 111 can more realistically simulate the charge time away from home, for example, in addition to the amount of charge or the number of times of charge away from home in the predetermined period based on the power capability information on the selected charge facility and the electric vehicle performance information. The simulation processor 111 has been described above.

Next, the output processor 112 will be described. The output processor 112 outputs, to the display 14 or the information processing device 40 via the communication network 60, charge information including at least any of the amount of charge and the number of times of charge required away from home, which are calculated by the simulation processor 111 on the assumption that the vehicle 20 owned by the user is replaced with the electric vehicle and the electric vehicle travels in a pattern similar to that of the vehicle 20. The above-described simulation will be described as an example. For example, the output processor 112 may output, to the display 14 or the information processing device 40 as the client terminal, the required amount of charge and the required number of times of charge away from home for each day of the week (j) (1≤j≤4) according to the electric vehicle type. In addition to the output of the required amount of charge and the required number of times of charge away from home, the output processor 112 may output, to the display 14 or the information processing device 40 as the client terminal, e.g., the total traveling distance and the amount of power required for the electric vehicle to travel the total traveling distance on each day of the week (j) (1≤j≤4), each inter-transit-point traveling distance and the amount of power required for the electric vehicle to travel each inter-transit-point traveling distance, the battery charge amount at the time of departure from home, and the battery charge amount at the time of arrival at each transit point. With this configuration, in a case where the vehicle is replaced with the electric vehicle, the user can easily grasp a change in the battery charge amount for each day of the week (j), and understand, for example, how much of the charging needs to occur away from home and the degree of battery consumption at each transit point. This leads to alleviation of the user's concerns regarding a replacement. The configuration of each function of the vehicle replacement simulation device 1 described as an exemplary embodiment has been described above.

Simple simulation for the vehicle type information A, B, C shown in FIG. 3 will be described as an example. For the electric vehicle A, for example, a home charge time of seven hours or more is ensured so that the home charge amount can be the same as the battery capacity. Similarly, for the electric vehicle B, a home charge time of 12 hours or more is ensured so that the home charge amount can be the same as the battery capacity. Similarly, for the electric vehicle C, for example, home charge (normal charge) is performed with 6 kW and a home charge time of 11 hours or more is ensured so that the home charge amount can be the same as the battery capacity. Thus, in the above-described case, in application of the simulation, such simulation is simple simulation under a condition where the departure charge amount is equal to the battery capacity of the electric vehicle.

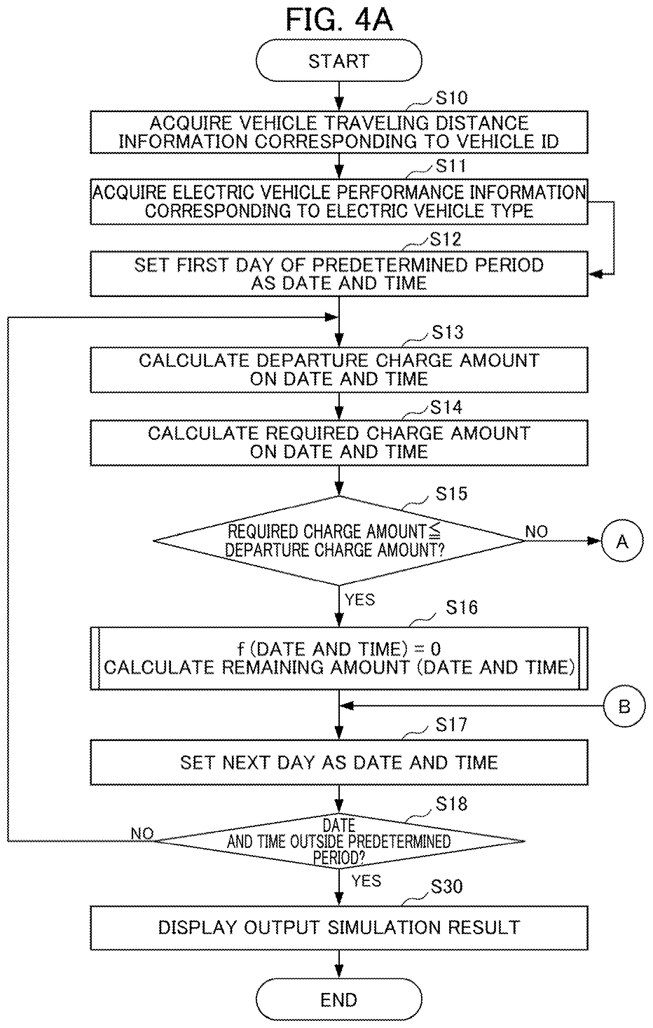

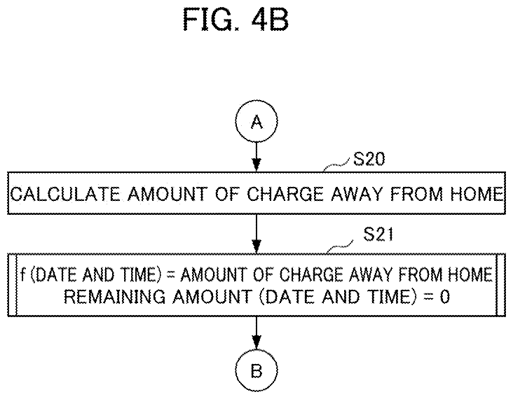

Next, operation of the present embodiment will be described with reference to flowcharts shown in FIGS. 4A and 4B. FIGS. 4A and 4B are the flowcharts showing the vehicle replacement simulation processing by the vehicle replacement simulation device 1. Specifically, the flow of processing will be described as an example, in which the vehicle replacement simulation device 1 simulates the charge information particularly including any of the amount of charge or the number of times of charge required at the charge facility away from home in a case where the vehicle 20 owned by the user is replaced with the electric vehicle and the electric vehicle travels in a pattern similar to the current traveling pattern of the vehicle 20. Note that in a case where the above-described simulation is performed for the electric vehicle of each of plural different vehicle types, the vehicle types may be selected one by one, and the simulation processing may be performed for one vehicle type selected in the flowcharts shown in FIGS. 4A and 4B. After the end of the simulation processing for such a vehicle type, the remaining vehicle types may be selected one by one, and similar processing may be performed therefor. Such processing is repeated for all the vehicle types specified so that the simulation processing can be performed for each of the plural different vehicle types.

In Step S10, the vehicle replacement simulation device 1 (vehicle information acquirer 110) acquires the vehicle traveling distance information associated with the vehicle ID of the vehicle 20 owned by the user in the predetermined period on a daily basis.

In Step S11, the vehicle replacement simulation device 1 (simulation processor 111) acquires the electric vehicle performance information (battery capacity, average electric cost, charge time (normal charge), and charge time (quick charge)) corresponding to the electric vehicle type targeted for simulation.

In Step S12, the vehicle replacement simulation device 1 (simulation processor 111) sets, as the date and time, the first day of the predetermined period targeted for simulation.

In Step S13, the vehicle replacement simulation device 1 (simulation processor 111) adds the home charge amount to the remaining battery charge amount on the previous day to calculate the charge amount (departure charge amount) of the electric vehicle at the time of departure from home. Here, the home charge amount is such a maximum amount of charge at home that the departure charge amount obtained by addition of the remaining battery charge amount on the previous day does not exceed the battery capacity of the electric vehicle.

In Step S14, the vehicle replacement simulation device 1 (simulation processor 111) calculates the amount of charge (required charge amount) of the electric vehicle required for the electric vehicle to travel a distance equal to the total traveling distance of the vehicle 20 on the date and time targeted for simulation based on the vehicle traveling distance information on the vehicle 20 on such date and time.

In Step S15, the vehicle replacement simulation device 1 (simulation processor 111) compares the required charge amount and the departure charge amount of the electric vehicle with each other. In the case of Required Charge Amount≤Departure Charge Amount, the processing proceeds to Step S16. In the case of Required Charge Amount>Departure Charge Amount, the processing proceeds to Step S20.

In Step S16, the vehicle replacement simulation device 1 (simulation processor 111) sets a function f (date and time) of 0 indicating the amount of charge away from home, and calculates the remaining battery charge amount on this date and time.

In Step S17, the vehicle replacement simulation device 1 (simulation processor 111) sets the next day as the date and time.

In Step S18, the vehicle replacement simulation device 1 (simulation processor 111) determines whether or not the date and time is away from the predetermined period. In a case where the date and time is outside the predetermined period, the processing proceeds to Step S30. In a case where the date and time is within the predetermined period, the processing proceeds to Step S13.

In Step S20, the vehicle replacement simulation device 1 (simulation processor 111) calculates the amount of charge required away from home by subtracting the departure charge amount from the required charge amount.

In Step S21, the vehicle replacement simulation device 1 (simulation processor 111) sets the amount of charge away from home to the value of the function f (date and time) indicating the amount of charge away from home, and sets the remaining battery charge amount to zero. Then, the processing proceeds to Step S17.

In Step S30, the simulation result in the predetermined period, which is estimated in a case where the vehicle 20 is replaced with the electric vehicle of the target vehicle type, is edited, and is output to the display 14 or the information processing device 40. Then, the simulation processing based on the electric vehicle of this vehicle type ends.

The processing has been described above, in which the vehicle replacement simulation device 1 estimates the charge information including the amount of charge and/or the number of times of charge required away from home in the predetermined period on the assumption that the vehicle 20 owned by the user is replaced with the electric vehicle corresponding to the predetermined vehicle type and the electric vehicle travels in a pattern similar to that of the vehicle 20 in the predetermined period.

Note that as a modification of the processing of the vehicle replacement simulation device 1, in a case where plural pieces of location information (transit point) on the location of parking of the vehicle 20 on the target date and time indicates the location information on the fueling facility, a value obtained by subtracting an inter-transit-point traveling distance in traveling immediately before the transit point which is the fueling facility as a destination and an inter-transit-point traveling distance in traveling immediately after the transit point which is the fueling facility as an origin from the total traveling distance may be applied as the total traveling distance of the vehicle 20 on such date and time. With this configuration, the amount of charging time required away from home in a case where the user replaces the vehicle with the electric vehicle can be more accurately calculated. In a case where the vehicle leaves home, but does not return home in the evening (or the night) (e.g., a family trip or a business trip), the traveling information is different from that in a normal traveling pattern, and therefore, may be excluded from the target for vehicle replacement simulation in the present embodiment. With this configuration, in terms of the amount of charge and/or the number of times of charge required away from home in a case where the user replaces the vehicle with the electric vehicle, the degree and necessity of charge on a daily basis can be more accurately calculated.

With the above-described configuration, on the assumption that the vehicle 20 owned by the user is replaced with the electric vehicle corresponding to the predetermined vehicle type and the electric vehicle travels in a pattern similar to that of the vehicle 20 in the predetermined period, the charge information including the amount of charge and/or the number of times of charge required away from home in the predetermined period can be easily grasped. Thus, objective information can be provided to the user in order to decide whether to replace the vehicle 20 with the electric vehicle.

Each type of equipment can be implemented by hardware, software, or a combination thereof. Moreover, a vehicle replacement simulation method performed by cooperation of the equipment included in the above-described vehicle replacement simulation system can also be implemented by hardware, software, or a combination thereof. Implementation by the software as described herein means implementation by reading and execution of a program by a computer.

The program can be stored using various types of non-transitory computer readable media and be supplied to the computer. The non-transitory computer readable media include various types of tangible storage media. Examples of the non-transitory computer readable media include magnetic recording media (e.g., a flexible disk, a magnetic tape, and a hard disk drive), magnetic optical recording media (e.g., a magnetic optical disk), a CD-read only memory (CD-ROM), a CD-R, a CD-R/W, and semiconductor memories (e.g., a mask ROM, a programmable ROM (PROM), an erasable PROM (EPROM), a flash ROM, and a random access memory (RAM)). The program may be supplied to the computer by means of various types of transitory computer readable media. Examples of the transitory computer readable media include an electric signal, an optical signal, and an electromagnetic wave. The transitory computer readable medium can supply the program to the computer via a wired communication path such as an electric wire or an optical fiber or a wireless communication path.

The above-described embodiment is a preferred embodiment of the present invention, but the scope of the present invention is not limited only to the above-described embodiment and various changes can be made without departing from the gist of the present invention.

### Modification 1

In the above-described embodiment, it has been described that the vehicle replacement simulation device 1 is implemented by, e.g., one server device. However, the vehicle replacement simulation device 1 may be a distributed processing system configured such that each function of the vehicle replacement simulation device 1 is distributed to a plurality of servers as necessary. Each function of the vehicle replacement simulation device 1 may be implemented using, e.g., a virtual server function on a cloud.

### EXPLANATION OF REFERENCE NUMERALS

100 Vehicle Replacement Simulation System
1 Vehicle Replacement Simulation Device
11 Controller
110 Vehicle Information Acquirer
111 Simulation Processor
112 Output Processor
12 Storage
121 Map Information Storage
123 Electric Vehicle Information Storage
13 Communicator
14 Display
15 Input
20 Vehicle
20A Mobile Terminal
30 Vehicle Traveling Information Database System (FCD Database System
40 Information Processing Device
60 Communication Network

What is claimed is:

1. A vehicle replacement simulation device comprising:
a map information storage that stores map information including charge facility information having road information and a location of a charge facility;
an electric vehicle information storage that stores electric vehicle performance information regarding traveling performance of an electric vehicle including a motor to be driven with electricity;
a vehicle information acquirer that acquires traveling information collected in a predetermined period and including at least location information on an internal combustion vehicle of a user including an internal combustion engine and clock time information and acquires traveling distance information including at least departure location information and parking location information on the internal combustion vehicle of the user including the internal combustion engine, clock time information, and a traveling distance in the predetermined period;
a simulation processor that calculates a required power amount from the traveling distance information on the internal combustion vehicle in the predetermined period and the electric vehicle performance information, calculates a parking time at a home of the user, estimates an amount of charge allowed at the home of the user based on the parking time at the home of the user, and further estimates, from the amount of charge allowed at the home, charge information including any of an amount of charge or the number of times of charge required away from the home based on the map information; and
an output processor that outputs the charge information to an information terminal of the user.

2. The vehicle replacement simulation device according to claim 1, wherein
the electric vehicle information storage stores the electric vehicle performance information for each of a plurality of electric vehicle types,
the simulation processor estimates the charge information for each of the plurality of electric vehicle types, and
the output processor outputs the charge information on each of the plurality of electric vehicle types.

3. The vehicle replacement simulation device according to claim 1, wherein
the map information storage stores power capability information regarding a power capability of a charger in the charge facility information, and
the simulation processor calculates, as charge information, a charge time in the predetermined period from the power capability information and the electric vehicle performance information.

4. The vehicle replacement simulation device according to claim 1, wherein
the map information storage stores information regarding a fueling facility for fueling the internal combustion engine in the map information, and
the simulation processor excludes, from the traveling information on the internal combustion vehicle, traveling information indicating the fueling facility for fueling the internal combustion engine as a destination of the internal combustion vehicle, and calculates the charge information.

5. The vehicle replacement simulation device according to claim 3, wherein
the map information storage stores information regarding a fueling facility for fueling the internal combustion engine in the map information, and
the simulation processor excludes, from the traveling information on the internal combustion vehicle, traveling information indicating the fueling facility for fueling the internal combustion engine as a destination of the internal combustion vehicle, and calculates the charge information.

6. A vehicle replacement simulation method executed by a computer, comprising:
a map information storage step of storing map information including charge facility information having road information and a location of a charge facility;
an electric vehicle information storage step of storing electric vehicle performance information regarding traveling performance of an electric vehicle including a motor to be driven with electricity;
a vehicle information acquiring step of acquiring traveling information collected in a predetermined period and including at least location information on an internal combustion vehicle of a user including an internal combustion engine and clock time information and acquiring traveling distance information including at least departure location information and parking location information on the internal combustion vehicle of the user including the internal combustion engine, clock time information, and a traveling distance in the predetermined period;
a simulation processing step of calculating a required power amount from the traveling distance information on the internal combustion vehicle in the predetermined period and the electric vehicle performance information, calculating a parking time at a home of the user, estimating an amount of charge allowed at the home of the user based on the parking time at the home of the user, and further estimating, from the amount of charge allowed at the home, charge information including any of an amount of charge or the number of times of charge required away from the home based on the map information; and
an output processing step of outputting the charge information to an information terminal of the user.
